(19) United States
(12) Patent Application Publication
(10) Pub. No.: US 2013/0017887 A1
(43) Pub. Date: Jan. 17, 2013

(54) Game Controller System

(71) Applicants: Wilson Keithline, New Britain, CT (US); Justin Morgenthau, South Windsor, CT (US)

(72) Inventors: Wilson Keithline, New Britain, CT (US); Justin Morgenthau, South Windsor, CT (US)

(21) Appl. No.: 13/546,809

(22) Filed: Jul. 11, 2012

Related U.S. Application Data
(60) Provisional application No. 61/507,817, filed on Jul. 14, 2011.

(51) Int. Cl. A63F 13/02

(52) U.S. Cl. 463/35; 463/36; 463/39; 463/38; 463/37

(57) ABSTRACT

A game controller comprising: a game controller housing; at least one user input device located on the game controller housing; a build digital data packet routine located in the game controller housing and in signal communication with the at least one user input devices; an add checksum routine located in the game controller housing and in signal communication with the build digital data packet routine; a convert to audio waveform routine located in the game controller housing and in signal communication with the add checksum routine; a headphone male connector attached to or on the game controller housing and in signal communication with the convert to audio waveform routine; where the headphone male connector is configurable to be in signal communication with an app on a computer device.

### CROSS-REFERENCES

This patent application claims the benefit of provisional patent application Ser. No. 61/507,817 by Wilson Keithline and Justin Morgenthau, entitled “Game Controller System”, filed on Jul. 14, 2011, the entire contents of which are fully incorporated by reference herein.

### TECHNICAL FIELD

The present invention relates generally to game controllers that are in signal communication with a smart phone or computer and more particularly game controllers that are in signal communication with a smart phone or computer via a headphone connector.

### BACKGROUND

The smartphone industry has created the opportunity to bring computer gaming to mobile and tablet devices. Independent software makers can develop games for these smart devices. The devices were originally designed as mobile phones and information devices. Most of them do not have good control or input devices for gaming.

Current smart phones utilize the touch screen capabilities of the smart devices to create a virtual control. In a traditional computer gaming device, the user holds a hand held electronic control and is able to provide input to the game computer via buttons or analog controls. In the current smartphones, the game controller may be simulated using touch screen buttons or other physical contact with the device screen.

There is one known device that sits on the screen and helps to enhance this interaction using physical contact with the screen. There are other products that are attempting to use standard game controllers and communicate wirelessly via Bluetooth or Wi-Fi or other wireless protocol with the smart devices. There are some that will use other I/O ports on the device like the USB or 30 pin connector to connect with the device. However, smart devices have a need for security. To enhance this security the device manufacturers limit the access to the device from external sources. So, for instance, the current iPhone does not allow external game control devices to connect via Bluetooth, WI-Fi, USB or 30 pin connector.

Thus there is a need for a game controller device and system that will overcome the above listed and other disadvantages.

### SUMMARY

The invention relates to a game controller system comprising: a game controller housing; at least one user input device located on the game controller housing; a build digital data packet routine located in the game controller housing and in signal communication with the at least one user input device; an add checksum routine located in the game controller housing and in signal communication with the build digital data packet routine; a transmission means located in or on the game controller housing and in signal communication with the add checksum routine; a receiving means located in a computer device, and configured to be in signal communication with the transmission means; a verify checksum routine located in the computer device, and in signal communication with the receiving means; a decode user input device states from data packet routine in signal communication with the verify checksum routine; a map user input device states to application functions routine in signal communication with the decode user input device states from data packet; a perform action in application routine in signal communication with the map user input devices states to application functions routine.

The invention also relates to a game controller comprising: a game controller housing; at least one user input device located on the game controller housing; a build digital data packet routine located in the game controller housing and in signal communication with the at least one user input devices; an add checksum routine located in the game controller housing and in signal communication with the build digital data packet routine; a convert to audio waveform routine located in the game controller housing and in signal communication with the add checksum routine; a headphone male connector attached to or on the game controller housing and in signal communication with the convert to audio waveform routine; where the headphone male connector is configurable to be in signal communication with an app on a computer device.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a top view showing the game controller system;

FIG. 2 shows a close up view of the headphone male connector;

FIG. 3 is another view of the game controller;

FIG. 4 is a perspective view of a computer device;

FIG. 5 is a view of the game controller with a both an tablet type computer device and a cell phone type computer device;

FIG. 6 is another embodiment of the game controller;

FIG. 7 shows several types of user input devices;

FIG. 8 is a schematic view of one embodiment of the game controller system; and

FIG. 9 is a schematic view of another embodiment of the game controller system.

### DETAILED DESCRIPTION

The disclosed system will take a standard or non-standard looking game controller and provide input capability through the headphone connector located on the smart phone or tablet computer, or any other computing device that can play games. With respect to this patent application, the phrase “computer device” will refer to any computer device that has a head phone connector, and is capable of playing computer games, including but not limited to: smart phones, tablet computers, iPhones, iPads, portable computers, lap top computers, and hand held computers. One embodiment of the disclosed system will work as follows: 1. the disclosed system utilizes the headphone port to connect the game controller to the computer device. 2. The game controller has a microprocessor in it. 3. The user presses a button on the game controller; the microprocessor sends a signal through the headphone connector to the computer device. 4. A piece of software resides on the computerdevice which interprets that signal and makes a corresponding action within the game on the computerdevice.

The disclosed system, in one embodiment, may comprise a standard looking handheld game controller with a headphone connector output device. The headphone connector output device will have the needed electronics to translate the inputs from the user into electrical signals which are compatible with the microphone input circuitry of the computer device. The system may also comprise software that resides on the computer device and that interprets the signals from the headphone connector output device within the smart device and then convert those signals to specific actions within a piece of gaming software.

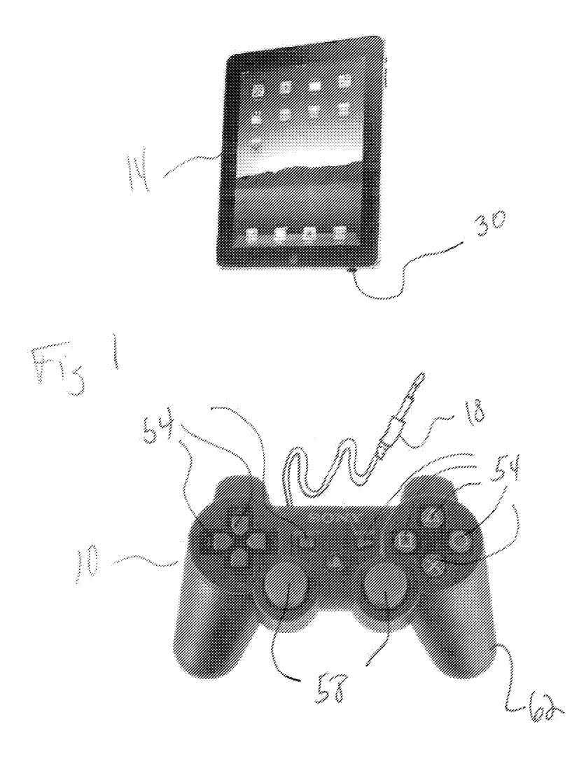

FIG. 1 shows a game controller 10 that may be placed in signal communication with a computer device 14. The game controller 10 is in signal communication with the computer device 14 through the headphone male connector 18 and the headphone female connector 30 on the computer device 14. The game controller 10 may have various user input devices, including but not limited to buttons 54, analog control (joy) sticks 58 located on a game controller housing 62. The signals from the game controller are received by the computer device 14 and translated in corresponding actions within a software application or game (hereinafter referred to collectively as an “app”) stored on or accessible by the computer device or game stored or accessible by the computer device 14. The app may be accessible to the computer device via the internet or more specifically through a cloud, where the cloud may be described as a model for enabling ubiquitous, convenient, on-demand network access to a shared pool of configurable computing resources (e.g., networks, servers, storage, applications, and services) that can be rapidly provisioned and released with minimal management effort or service provider interaction.

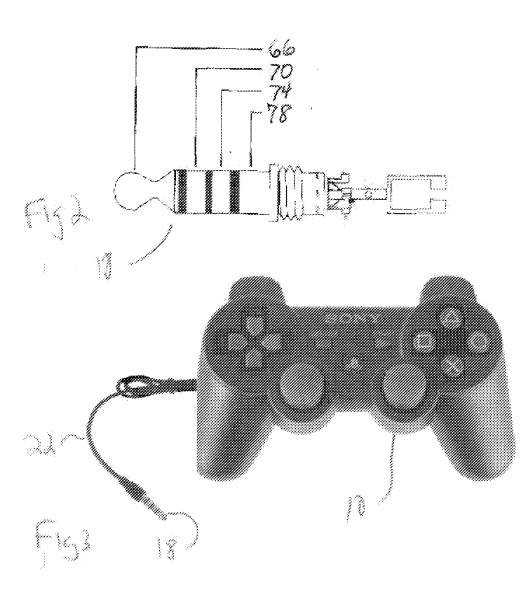

FIG. 2 shows a close up view of the headphone male connector 18. The headphone male connector 18 may comprise a speaker right portion 66, a speaker left portion 70, a microphone portion 74, and a ground portion 78. Of course, other configurations for male connectors may be used and are included in this disclosure. The game controller 10 may have an integrated circuit (IC) that translates the signal from the game controller input and sends an output signal through the microphone portion of the headphone male connector 18. The IC may send the data using a modified Manchester Encoding scheme with low-to-high transition, using 9 bits per packet (8 data+1 parity), including a check sum; in one embodiment. A header byte may be used to synchronize communications and determine command type bytes are transmitted MSB-first. The computer device 14 (an iPhone for example) may sample at about 44100 HZ and can receive signals at about 5000 baud or more. This allows for a very low latency between the user pressing an input button on the controller and response by the computer device.

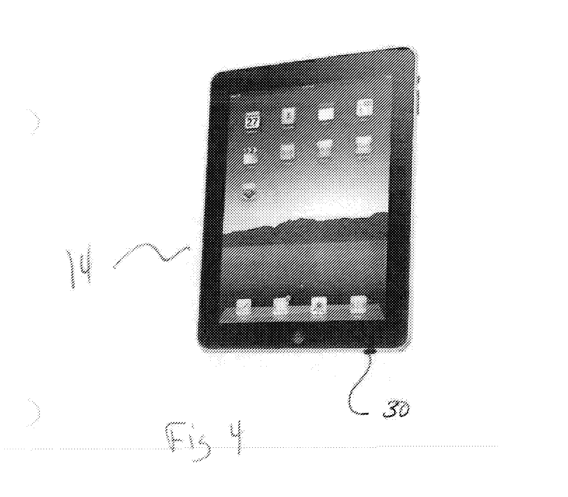

FIG. 3 shows the game controller 10, with the headphone male connector 18. The headphone male connector 18 may be in communication with the game controller 10 via a wire 22. In other embodiments, the game controller 10 may be in wireless signal communication with the computer device 14.

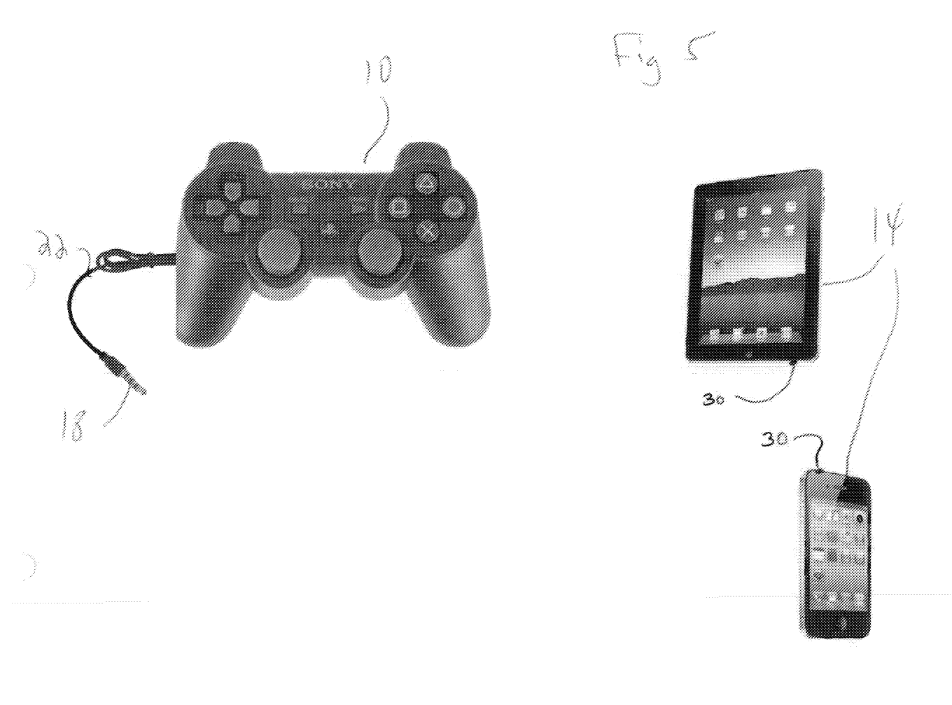

FIG. 4 shows a computer device 14 with a headphone female connector 30. The computer device 14 allows third party developers to create apps or games that operate on device. The app developers may be provided a software development kit (a piece of software that resides within their app) that translates the signals sent from the disclosed game controller 10 to create corresponding actions in their app or game. For example, a user presses a button on the game controller 10, causing a signal to be sent to the IC in game controller 10. The IC translates the signal into a signal which is sent through headphone male connector 18 (which may be Manchester encoded). The computer device 14 receives the signal through headphone female connector 30 microphone port. Software on the computer device 14 translates the signal into a response in the app or game. The app or game software responds with a corresponding action.

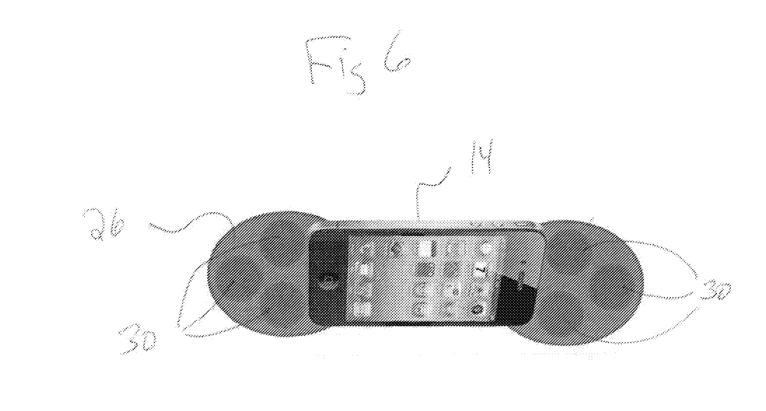

FIG. 5 shows the game controller 10 with the headphone male connector 18, along with two examples of computer devices 14. Since the game controller system uses a headphone connector, the product is interoperable with a number of different computer, tablets, mobile phones, MP3 devices or headphone enabled computer type devices.

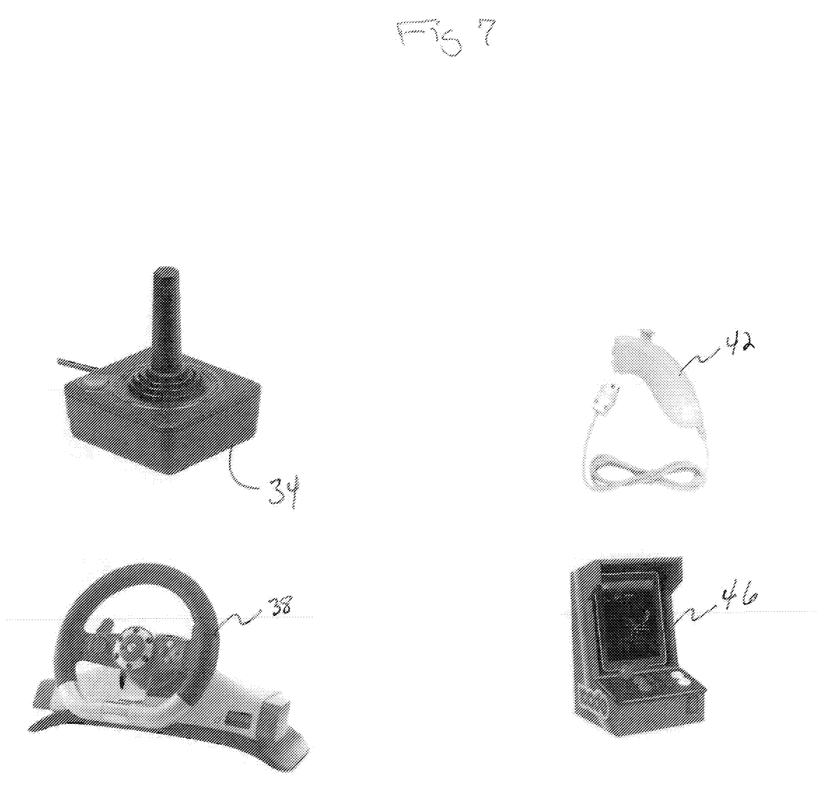

FIG. 6 shows an embodiment of the game controller 26 that may be directly attached to the computer device 14. The headphone connector is not visible, but is connected into the headphone receptacle on the computer device 14. Control buttons 30 are shown on the game controller 26. The game controller 26 could be a separate device or part of a case that is in contact with the computer device 14.

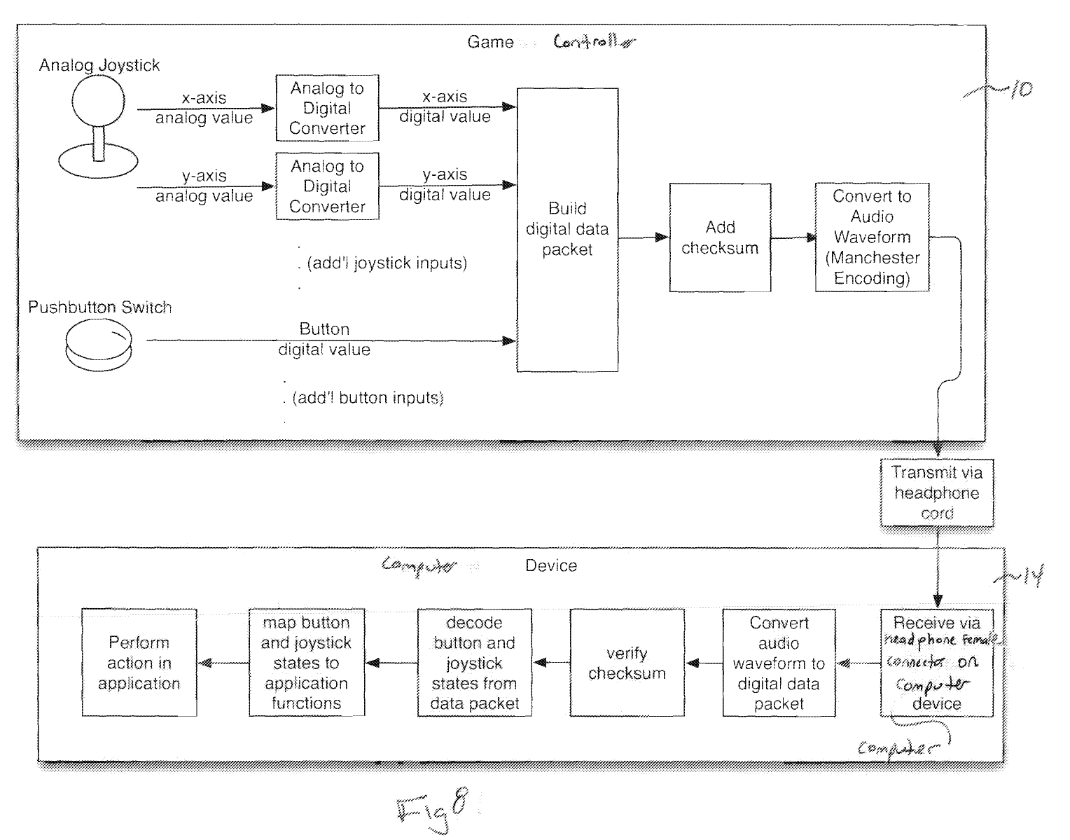

FIG. 7 shows other game controllers that can be easily adapted to use the disclosed headphone male connector 18 and wire 22 (or wireless) to communicate with a computer device 14. Such game controllers include but are not limited to a joystick, steering wheel and/or vehicle controls, nunchuck and arcade style game controllers.

As computer devices 14 such as smart phones and tablets become more mature, they are beginning to incorporate new low power wireless technologies. So the disclosed game controller system may include the ability to communicate wirelessly (using standard protocols) with those devices that have the wireless capability and using the headphone jack solution for those devices that do not have that capability. For example, the disclosed game controller system 10 may have Bluetooth low energy and headphone jack technology incorporated inside the controller allowing it to be compatible with a large number of computer devices.

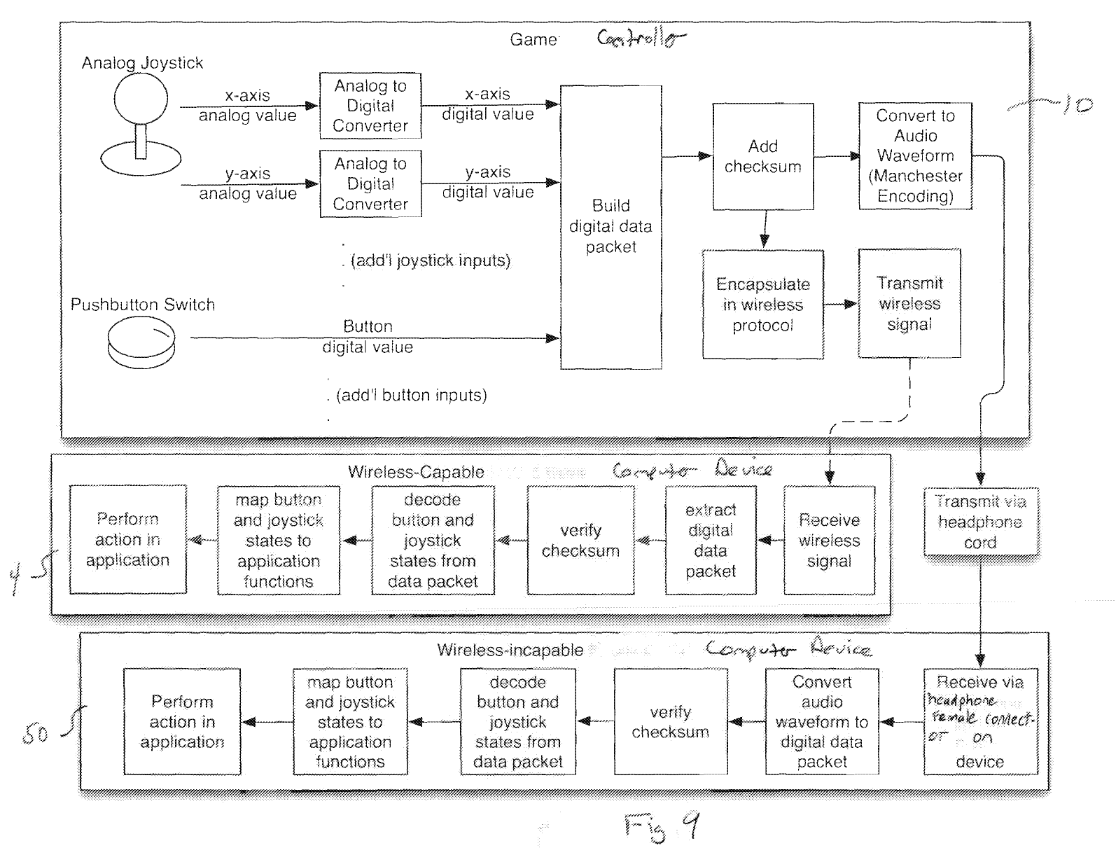

FIG. 8 is a schematic showing one embodiment of the game controller system 10 and the computer device 14. In this figure, the game controller system 10 is configured to work with a computer device 14 that either does not have wireless capability, or the wireless feature is turned off. If the game controller has an analog joy stick, then x-axis and/or y axis data is created during the user's movement of the joystick. The data (value) is transmitted to an analog to digital converter which converts the analog value to a digital value. The x-axis and y-axis digital values are then transmitted to a build digital data packet routine. Also, if the game controller system has a push button switch, then the button digital value is transmitted to the build digital data packet routine. The data packet is then sent to an add checksum routine. Next the data is sent to a convert to audio waveform (Manchester encoding) routine. Next the audio waveform is transmitted by wire 22 (also known as the headphone cord) to the computer device 14. The audio waveform is sent to a convert audio waveform to digital data packet routine. Next the digital data packet is sent to a verify checksum routine. Next the data packet is sent to a map button and joystick states to application functions routine. Finally the application (or game) performs the action in the application.

FIG. 9 is a schematic showing one embodiment of the game controller system 10 and the computer device 14. In this figure, the game controller system 10 is configured to be able to work with either a computer device 50 that does not have wireless capability, or a computer device 14 that does have wireless capability. If the game controller has an analog joy stick, then x-axis and/or y axis data is created during the user's movement of the joystick. The data (value) is transmitted to an analog to digital converter which converts the analog value to a digital value. The x-axis and y-axis digital values are then transmitted to a build digital data packet routine. Also, if the game controller system has a push button switch, then the button digital value is transmitted to the build digital data packet routine. The data packet is then sent to an add checksum routine. Next the data is sent to a convert to audio waveform (Manchester encoding) routine. Next the audio waveform is transmitted by wire 22 (also known as the headphone cord) to the computer device 50. The audio waveform is sent to a convert audio waveform to digital data packet routine. Next the digital data packet is sent to a verify checksum routine. Next the data packet is sent to a map button and joystick states to application functions routine. Finally the application (or game) performs the action in the application.

Still referring to FIG. 9, optionally, the data packet may be sent from the add checksum routine (in the game controller system 10) to a routine that encapsulates the data packet in a wireless protocol. Then the data packet is transmitted by wireless signal to the computer device 14. The computer device 14 receives the wireless signal. Then the signal is sent to an extract digital data packet routine. Next the data packet is sent to a verify checksum routine. Next the data packet is sent to a map button and joystick states to application functions routine. Finally the application (or game) performs the action in the application.

The disclosed invention has many advantages. There are no products currently on the market which offer the classic game controller experience on these smart devices. The disclosed invention solves the security and interface issues that are slowing the acceptance of external game controllers on these computer devices. Since the disclosed invention uses a standard interface found on most devices, the headphone connector, it can be made interoperable with a large number of devices.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A game controller system comprising:
a game controller housing;
at least one user input device located on the game controller housing;
a build digital data packet routine located in the game controller housing and in signal communication with the at least one user input device;
an add checksum routine located in the game controller housing and in signal communication with the build digital data packet routine;
a transmission means located in or on the game controller housing and in signal communication with the add checksum routine;
a receiving means located in a computer device, and configured to be in signal communication with the transmission means;
a verify checksum routine located in the computer device, and in signal communication with the receiving means;
a decode user input device states from data packet routine in signal communication with the verify checksum routine;
a map user input device states to application functions routine in signal communication with the decode user input device states from data packet;
a perform action in application routine in signal communication with the map user input devices states to application functions routine.

2. The game controller system of claim 1, further comprising:
a convert to audio waveform routine in signal communication with the add checksum routine and the transmission means;
a convert audio waveform to digital data packet routine located in the computer means and in signal communication with the verify checksum routine located in the computer device and in signal communication with the receiving means;
wherein the transmission means is a headphone male connector attached to the game controller housing; and
wherein the receiving means is a headphone female connector on the computer device.

3. The game controller system of claim 2, wherein the convert audio waveform routine uses Manchester encoding.

4. The game controller system of claim 1, further comprising:
an encapsulate in wireless protocol routine in signal communication with the add checksum routine in the game controller housing and in signal communication with the transmission means;
an extract digital data packet routine located in the computer device and in signal communication with the receiving means and in signal communication with the verify checksum routine;
wherein the transmission means is a wireless transmitter located in or on the game controller housing; and
and wherein the receiving means is a wireless receiver located in or on the computer device.

5. The game controller system of claim 1, further comprising:
at least one analog to digital converter located in the game controller housing in signal communication with at least one user input devices and the build digital data packet routine.

6. The game controller system of claim 5, wherein at least one of the at least one user input device is a joystick, and at least one of the at least one analog to digital controller is in signal communication with the x-axis analog value from the joystick; and at least one other of the at least one analog to digital controller is in signal communication the y- axis analog value from the joystick.

7. The game controller system of claim 1, wherein the at least one of the at least one user input devices is a button, and the build digital data packet routine is in signal communication with the button digital value from the button.

8. A game controller comprising:
a game controller housing;
at least one user input device located on the game controller housing;
a build digital data packet routine located in the game controller housing and in signal communication with the at least one user input devices;
an add checksum routine located in the game controller housing and in signal communication with the build digital data packet routine;
a convert to audio waveform routine located in the game controller housing and in signal communication with the add checksum routine;
a headphone male connector attached to or on the game controller housing and in signal communication with the convert to audio waveform routine;
wherein the headphone male connector is configurable to be in signal communication with an app on a computer device.
